(19) United States
(12) Patent Application Publication
(10) Pub. No.: US 2005/0023787 A1
(43) Pub. Date: Feb. 3, 2005

(54) Braking system for hand cart

(76) Inventor: Thomas L. Haynes, Chittenango, NY (US)

Correspondence Address: BOND, SCHOENECK & KING, PLLC, ONE LINCOLN CENTER, SYRACUSE, NY, 13202-1355, US

(21) Appl. No.: 10/893,676

(22) Filed: Jul. 16, 2004

Related U.S. Application Data
(60) Provisional application No. 60/491,756, filed on Aug. 1, 2003.

(51) Int. Cl. B62B 3/00

(52) U.S. Cl. 280/79.11

(57) ABSTRACT

A braking system primarily intended for use in a cargo-carrying cart of conventional type having a swivel caster at the front and rear ends and a pair of wheels rotatable upon a stationary axle extending across the longitudinal midpoint of the cart. The system includes a brake assembly inwardly adjacent each of the two wheels, each assembly having a rotor affixed to one end of a hollow, cylindrical a hub with a plurality of notches extending axially into the other end. The rotor and hub are rotationally coupled to the cart wheels by the wheel spokes extending into the hub notches. Inboard and outboard brake plates are positioned on opposite sides of each rotor. A pair of cables extends between the outboard brake plates on of the two brake assemblies, one on each side of a vertical plane through the rotational axis of the wheels, rotor and hubs. When tension is applied to one or both of these cables, the outboard plates are drawn inwardly to contact the rotors, and the rotors are moved laterally to contact the inboard plates, thereby engaging the brakes and inhibiting rotation of the wheels. In a first embodiment, the brakes are normally engaged, being disengaged to permit movement of the cart only upon operator movement of a push bar assembly to which a cable is attached for releasing tension on the brake plate cables. In another embodiment, the brakes are normally disengaged, becoming engaged upon operator manipulation of a handle assembly to which a cable is attached for applying tension to the brake plate cables. In both embodiments, the braking system is operable from either end of the cart.

### CROSS-REFERENCE TO RELATED APPLICATIONS

The present application claims priority to U.S. Provisional Application Ser. No. 60/491,756 of the same title, filed on Aug. 1, 2003, and hereby incorporated by reference.

### BACKGROUND OF THE INVENTION

The present invention relates to braking systems particularly useful in cargo transporting carts. More specifically, the invention may be advantageously employed in apparatus designed for installation on existing hand carts which may be pushed from either of two, opposite ends.

A type of hand or push cart which has been popular for many years includes a flat bed having opposite ends and sides with a single wheel in the form of a swivel caster mounted at the longitudinal centerline of the cart adjacent each end, and a pair of wheels mounted on a common axle adjacent each side of the cart midway between the ends. A structure suitable for manual engagement to push the cart in either direction, or to pivot or otherwise maneuver the cart, is affixed to, and extends upwardly from, each end of the bed. Such carts are extremely sturdy and durable, capable of supporting thousands of pounds of cargo and having a useful life of many decades. One particularly popular application of such carts is in the postal field for transporting items of mail within mail centers and similar facilities.

One drawback which has been encountered in the use of such hand carts is the lack of a braking system. It will be readily appreciated that a cart loaded with any sort of heavy cargo can do significant damage to both property and personnel if accidentally moved, either directly by hand or under its own momentum if released while in motion, to collide therewith. Although it has been recognized that the use of the aforementioned carts in the Postal Service, wherein they are commonly known as tilt-type platform trucks, presents a serious safety hazard, no satisfactory braking system has heretofore been devised.

It is a principal object of the present invention to provide a simple yet effective and reliable braking system for cargo-carrying carts.

Another object is to provide braking means which may be installed on a popular type of wheeled cart presently in use.

A further object is to provide a braking system operable from either of opposite ends of a cargo cart designed to be pushed by an operator positioned at either end.

Still another object is to provide braking apparatus for a push cart wherein the brake is applied at all times other than when released by an operator manually engaging the pushing structure.

A still further object is to provide a novel and improved braking system for wheeled vehicles, principally those having a cargo bed with a frame supported on swivel casters and a pair of spoked wheels rotatable about a single, stationary axle.

Additional objects will partly be obvious and partly appear hereinafter.

### SUMMARY OF THE INVENTION

In accordance with the foregoing objects, the invention comprises a braking system of the friction type having components for mounting upon a conventional type of push cart. The carts for which the disclosed embodiments of the invention are designed for use have a rigid, metal frame supporting a flat cargo bed, a single, swivel-caster wheel mounted to the frame below and adjacent each end of the bed, and a pair of wheels rotatable about a stationary axle supported below the frame and extending across the lower side of the bed midway between the ends. Although carts of this type are sometimes termed tilt-type platform trucks, for purposes of the present application they will simply be termed carts or push carts. The axle-mounted wheels are of cast metal, having a plurality of spokes extending between the rim and a hub carrying a suitable bearing. Structure for manual engagement to push the cart extends upwardly from the upper side of the bed at each end thereof.

In the braking system of the invention, a flat, circular rotor is coaxially connected to one end of a hollow, cylindrical hub having a plurality of notches extending axially into the other end. The notches correspond in number and width to the spokes on the inwardly facing side of each wheel. One of these rotor and hub assemblies is mounted upon the axle inwardly adjacent each wheel with the wheel spokes extending into the notches in the hub. The rotor and hub assembly includes a suitable bearing permitting free rotation of the assembly, as well as limited lateral movement, with respect to the stationary axle and the wheel. Thus, rotation of the wheels when the cart is in motion is transmitted to the hub and rotor assemblies. A caliper assembly, comprising an inboard brake pad or plate, an outboard plate, and a spacer, is mounted adjacent each rotor. The inboard plates are rigidly mounted to portions of the cart frame and the spacers are rigidly mounted to the inboard plates. The outboard plates are flexibly mounted to the spacer with outer portions of the rotor surfaces between opposing surfaces of the inboard and outboard plates of each caliper assembly. Flexible cables are attached at opposite ends to the outboard plates, one such cable on one side and one on the other side of a vertical plane through the axle. Placing either or both of these cables in tension moves the outboard plate into contact with one side of the rotor, and moves the rotor to place its other surface into contact with the inboard plate. This frictionally inhibits rotation of the rotor and, through the spoke-engaged hub, applies a braking action to the axle-mounted wheels of the cart.

The braking system is shown and described in two embodiments, denoted “normally on” and “normally off.” In the normally on version, opposing surfaces of the brake plates are spring-biased into engagement with the rotor, thereby substantially locking the axle-mounted wheels in position and preventing movement of the cart, until the plates are removed from contact with the rotor by operator manipulation of the cable(s), preferably by manual engagement of a bar, or the like, positioned conveniently upon the pushing frame. Upon release of this bar, whether intentionally or inadvertently, the plates are spring-biased back into engagement with the rotor and essentially lock the cart against further movement. The brake may be released by manual engagement of either of two bars, one positioned at each end of the cart. In the normally off embodiment, the pads are not biased toward the braking position and move to engage the rotor only upon operator manipulation of the cables through a handle structure; the cart may continue in motion until the brakes are manually applied, even though the operator is no longer in manual contact with any portion of the cart. The normally on embodiment is shown in a second, preferred version, employing sheathed cables to connect the manually engageable bars with the brake operating system.

The foregoing and other features of construction and operation of the invention will be more readily understood and fully appreciated from the following detailed description, taken in conjunction with the accompanying drawings.

### BRIEF DESCRIPTION OF THE DRAWINGS

FIG. 1 is a side elevational view of a hand cart equipped with a first embodiment of the braking system of the invention, shown with brakes engaged;

FIG. 2 is a bottom plan view of the cart and braking system of FIG. 1;

FIGS. 3 and 4 are side elevational and bottom plan views, respectively, of the cart and braking system of FIGS. 1 and 2, shown with the brakes disengaged;

FIG. 5 is an end view of the cart and braking system of FIGS. 1-4;

FIG. 6 is a fragmentary, perspective view of portions of the cart and braking system;

FIGS. 7 and 8 are side elevational and bottom plan views, respectively, of the cart equipped with a second embodiment of the braking system of the invention, shown with the brakes engaged;

FIGS. 9 and 10 are side elevational and bottom plan views, respectively, of the second embodiment, shown with the brakes disengaged; and

FIG. 11 is an end view of the second embodiment.

FIGS. 12, 13 and 14 are side elevational, bottom plan and end elevational views, respectively, of a alternate, preferred version of the first embodiment of the cart, with portions in section, shown with the brakes engaged;

FIG. 15 is an exploded perspective view of the elements of the brake control system of the cart of FIGS. 12-14;

FIGS. 16, 17 and 18 are perspective views of the elements of FIG. 15 in assembled relation, shown in their respective positions with the brakes are engaged, with the brakes disengaged when actuated from one end of the cart, and with the brakes disengaged when actuated from the other end of the cart, respectively;

FIG. 19 is a fragmentary, side elevational view in section on the line 19-19 of FIG. 14, with portions broken away; and

FIG. 20 is a sectional view taken on the line 20-20 of FIG. 19.

### DETAILED DESCRIPTION

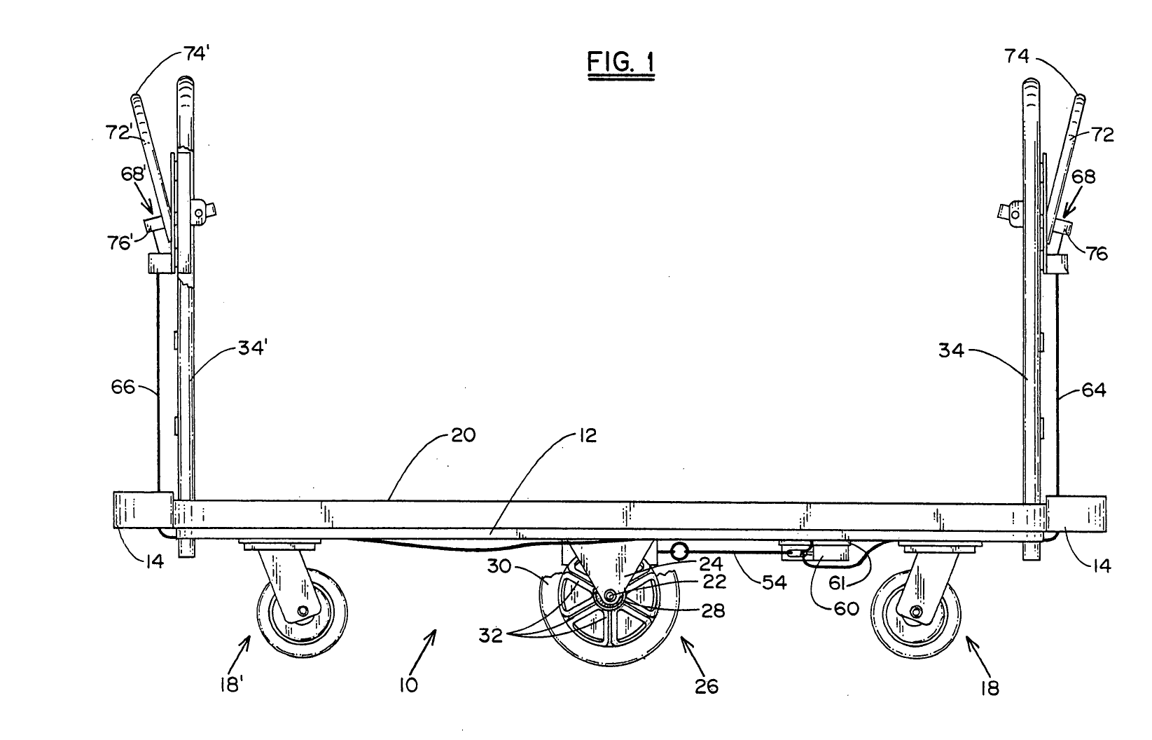

Referring now to the drawings, in FIG. 1 is shown a hand cart, denoted generally by reference numeral 10, including a rigid, metal frame 12 having bumper structures 14, 14′. Pivoting caster assemblies 18, 18′, are attached to plates forming part of the frame and extend downwardly adjacent each end. Cargo carrying bed 20, e.g., of heavy wooden planks, is supported upon frame 12. Stationary axle 22 is mounted at opposite ends upon support members 24, 24′, extending downwardly from frame 12 on opposite sides of the cart substantially at the transverse centerline. A pair of wheels 26, 26′, formed as solid metal castings, each include a hub 28, 28′ supported coaxially of a rim 30, 30′ by a plurality of spokes 32, 32′. Fixedly attached to, and extending upwardly from, frame 12 or bed 20 at each end of cart 10 are frame structures 34, 34′ for manual engagement by an operator to move and maneuver cart 10. To aid in such movement and maneuverability, a plane through the lower surfaces of wheels 26, 26′ and parallel to the plane of bed 20 is spaced further from the bed than a plane through the lower surfaces of the wheels of caster assemblies 18, 8′; that is, with wheels 26, 26′ engaging an underlying, horizontal surface, only one at a time of the caster wheels engages the surface, depending on the direction in which manual force is applied to structures 34, 34′. As previously stated, a conventional form of cart 10, substantially as described in this paragraph, has been in use for many years in applications including the moving of items of mail within postal centers throughout the United States, but have had no braking system of any kind, relying entirely upon manual force applied by the operator, as well as the forces of friction and gravity, to bring the cart to a stop and/or to maintain it in a stationary position.

The braking system of the present invention may be mounted as a retrofit upon existing carts of this type, or may, of course, be incorporated in newly manufactured carts. Mounted inwardly adjacent each of wheels 26, 26′ are brake assemblies 36, 36′, each including a hollow, cylindrical hub 38, 38′, a flat, round disc or rotor 40, 40′, an inboard pad or plate 42, 42′, an outboard pad or plate 44, 44′ and a spacer 46, 46′. Hubs 38, 38′ are fixedly connected at one end to rotors 40, 40′ either by welding or bolting, or, preferably, by forming the hubs and rotors as unitary, metal castings. In either case, the hub and rotor are concentric and contain bearing means suitable for mounting and rotation, as well as a limited amount of lateral movement, upon axle 22. A plurality of notches 48, 48′ extend axially from the open end of hubs 38, 38′, respectively, opposite the end connected to rotors 40,40′.

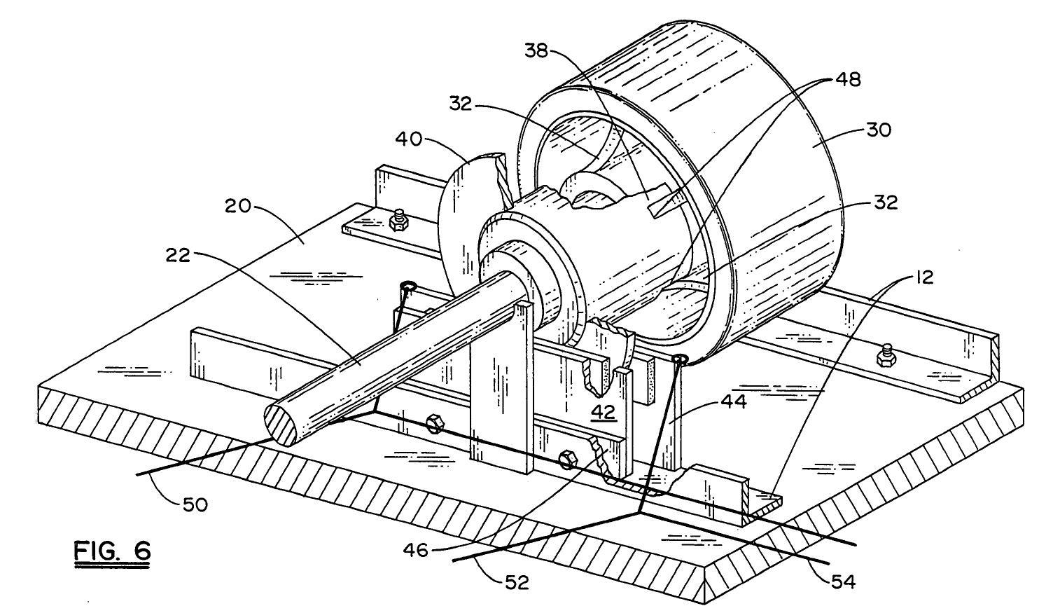

The rotor and hub of assemblies 36, 36′ are mounted upon axle 22 with hubs 38, 38′ facing outwardly and spokes 32, 32′ extending into notches 48, 48′. The number of notches in each hub is equal to the number or spokes in the wheels of the cart for which the braking system is designed, commonly five or six. Engagement of the spokes in the hub notches rotationally couples wheels 26, 26′ and rotors 40, 40′. Inboard brake plates 42, 42′ are fixedly mounted to frame 12, e. g., by bolting, as seen in the case of plate 42 in FIG. 6. Still with reference to FIG. 6, spacer 46 (and an identical spacer on the other brake assembly) are fixedly mounted to inboard plates 42, 42′, and outboard plates 44, 44′ are flexibly mounted to the spacers, for example, by a pair of shoulder bolts with lock or Bellville washers between the spacers and outboard plates tightened only to the point of applying slight pressure to the plate.

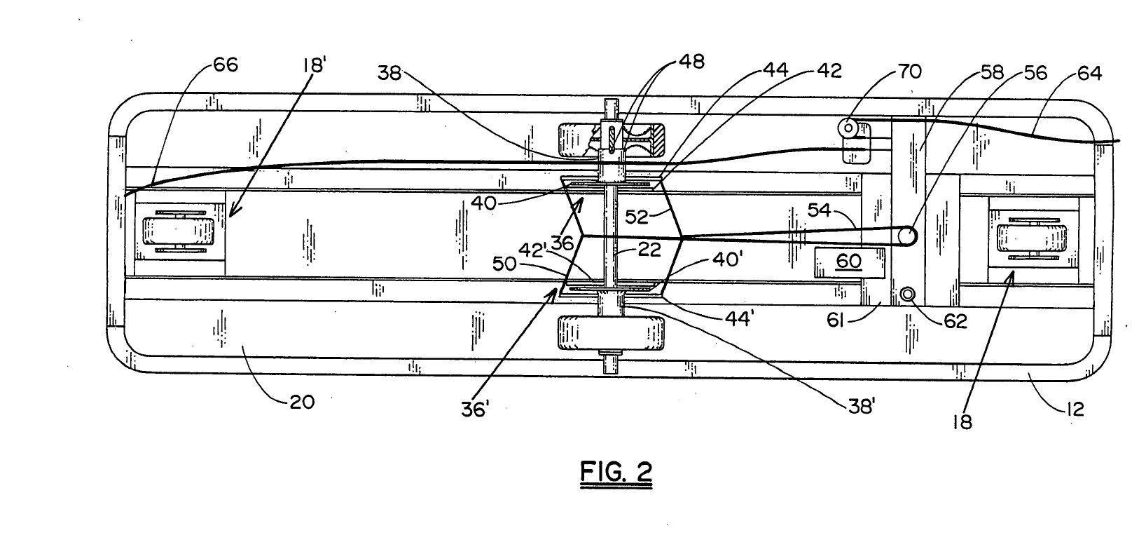

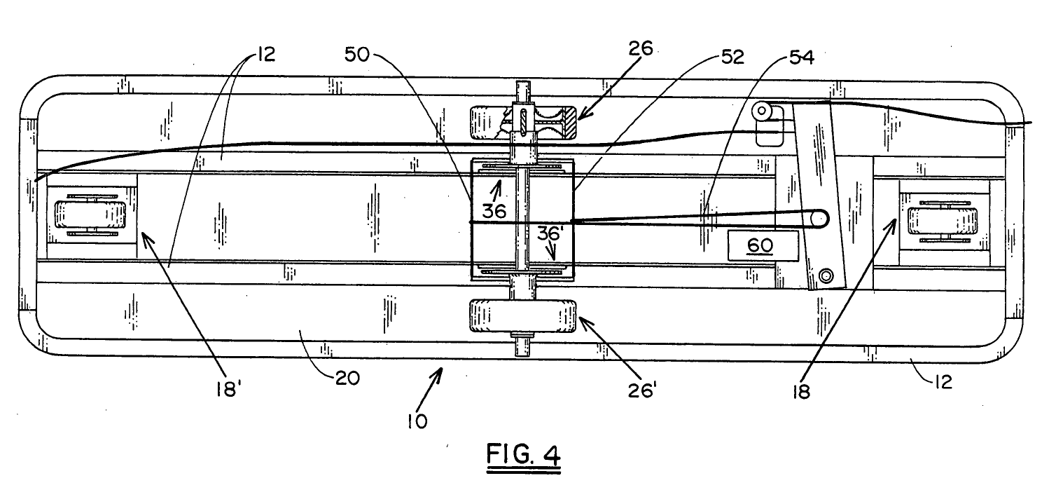

Cable 50 is connected at opposite ends to outboard plates 44, 44′, adjacent one end of each, on one side of a vertical plane through axle 22, and cable 52 is connected at opposite ends to outboard plates 44, 44′ adjacent the other ends of the plates on the other side of such plane. Cable 54 is attached at opposite ends to cables 50 and 52 at or near the mid-point of each. Intermediate of its connections to cables 50 and 52, cable 54 passes around post 56 on lever 58. Spring pack 60 is fixedly mounted upon plate 61, which is affixed to frame 12, and exerts a biasing force on lever 58 in the clockwise direction, as viewed in FIGS. 2 and 4, about pivot pin 62. Cables 64 and 66 are each affixed at one end to lever 58, or to structure fixedly connected to the lever, and extend to manually engageable structures 68, 68′ mounted to pushing structures 34, 34′, respectively. Cable 64 passes around pulley 70 between its connections to lever 58 and structure 68 and cable 66 passes directly from lever 58 to structure 66′, whereby application of tension to either of cables 64 and 66 moves lever 58 in a counter-clockwise direction, against the bias of spring pack 60, from the position shown in FIG. 2 to that shown in FIG. 4.

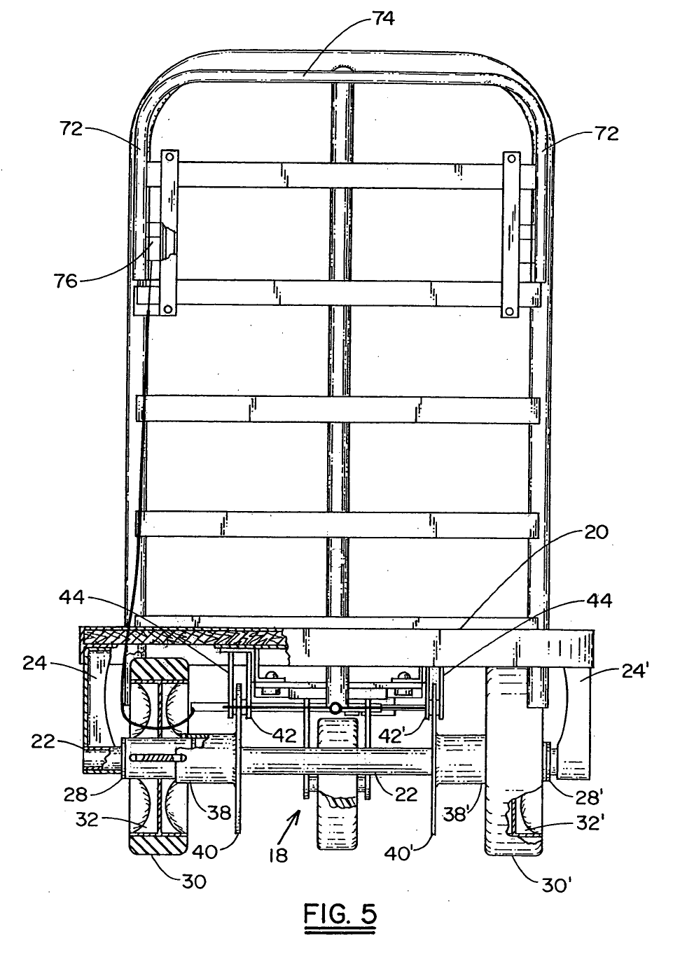

The structure and operation of manually engageable structures 68, 68′ may be seen by reference to FIGS. 1, 3 and 5. U-shaped bars includes parallel legs 72, 72′, each pivotally mounted upon clamps attached to structure 34, 34′ and joined by horizontally extending bars 74 74′, respectively. Cables 64 and 66 are connected at one end to brackets 76, 76′ which are mounted for rotation together with the U-shaped bars. The length of cables 50, 52 and 54, and the position of lever 58 and post 56 in FIGS. 1 and 2, are such that cable 54 is in tension, and applies tension to cables 50 and 52, thereby flexing outboard brake plates 44, 44′ inwardly, against the outer surfaces of rotors 40, 40′ and moving the rotors inwardly against inboard brake plates 42, 42′. The opposing surfaces of plates 42, 42′, 44 and 44′, i.e., the surfaces which contact opposite sides of rotors 40, 40′, are of brake lining material and thus frictionally engage the rotor to impede rotation thereof. The rotational locking of the rotor hubs with the wheel spokes effectively prevents movement of cart 10 when the brakes are engaged, as in FIGS. 1 and 2.

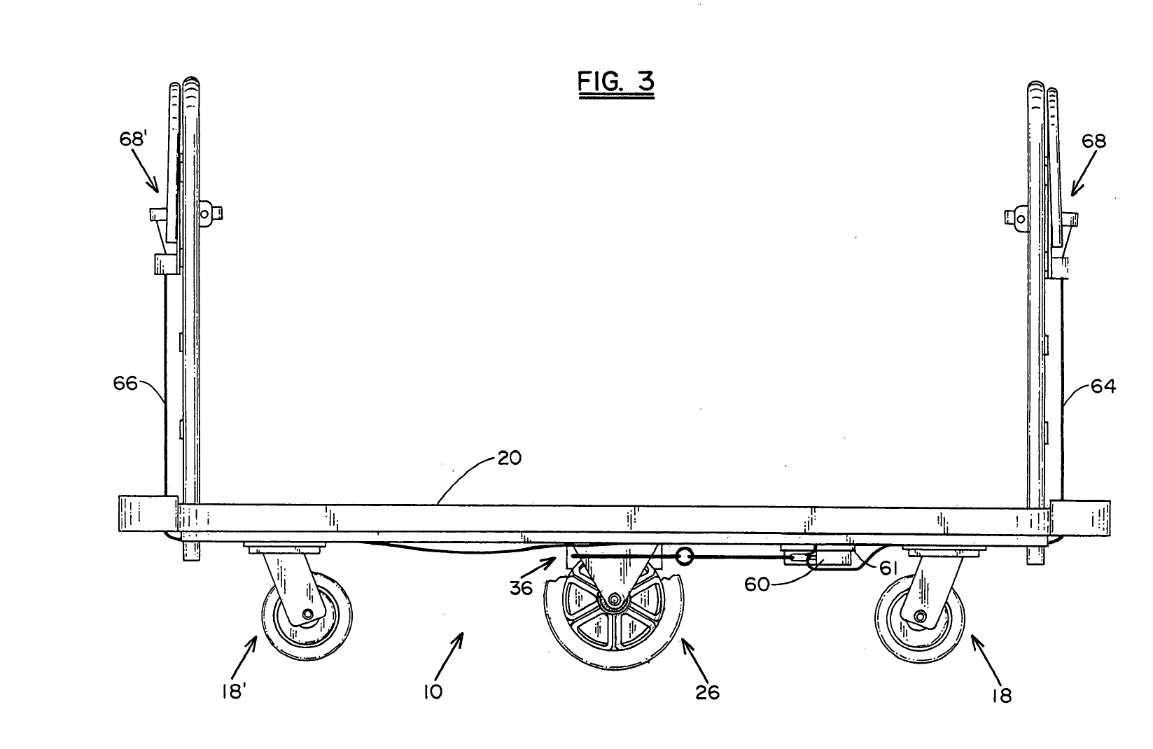

In order to move cart 10, the operator manually engages one or the other of horizontal bars 74, 74′ and pushes it toward the upper, horizontal member of structure 34, 34′, thereby rotating the U-shaped bar and associated bracket 76, 76′. Movement of the bracket places tension upon the associated cable 64, 66 and moves the cable to rotate lever 58 against the bias of spring pack 60. Counterclockwise rotation of lever 58 removes the tension on cables 64 and 66, thereby removing tension from cables 50 and 52. With cables 50 and 52 slack, outboard brake plates 44, 44′ return to their unflexed positions and rotors 40, 40′ is no longer frictionally engaged between the brake plates. The brakes are then disengaged and the elements are in the positions shown in FIGS. 3 and 4. Cart 10 may be moved by the operator, but only as long as one of bars 74, 74′ is held in the rotated position. Release of both bars 74, 74′ will permit spring pack 60 to rotate lever 58 back to the position of FIGS. 1 and 2, placing tension on cables 54, 52 and 50, thereby applying and engaging the brakes.

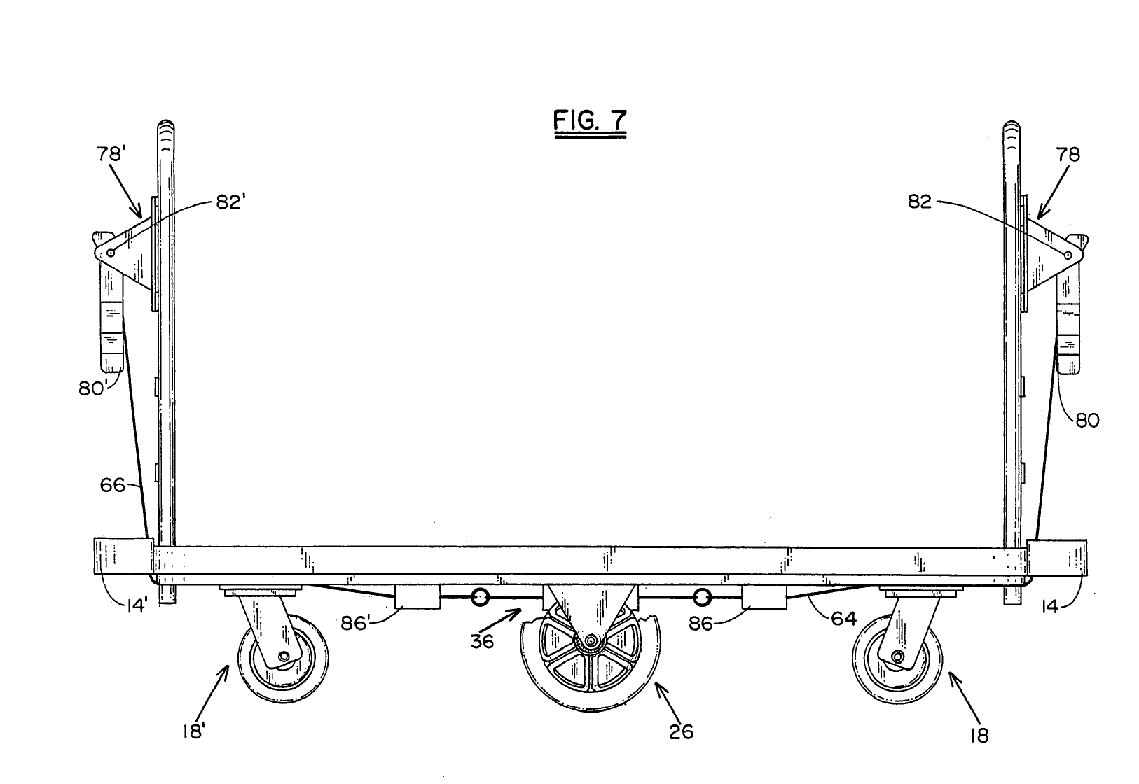

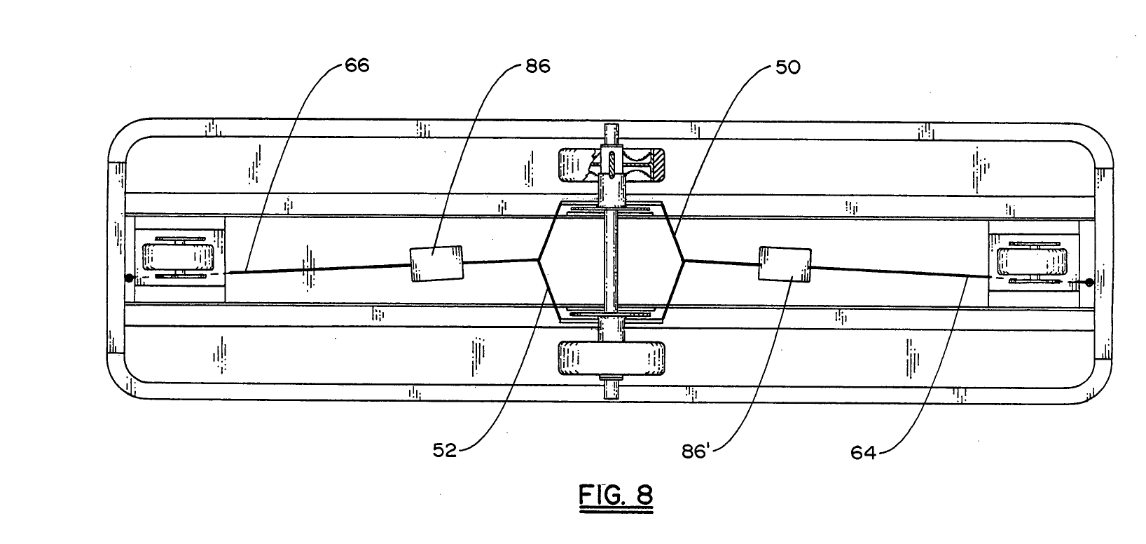

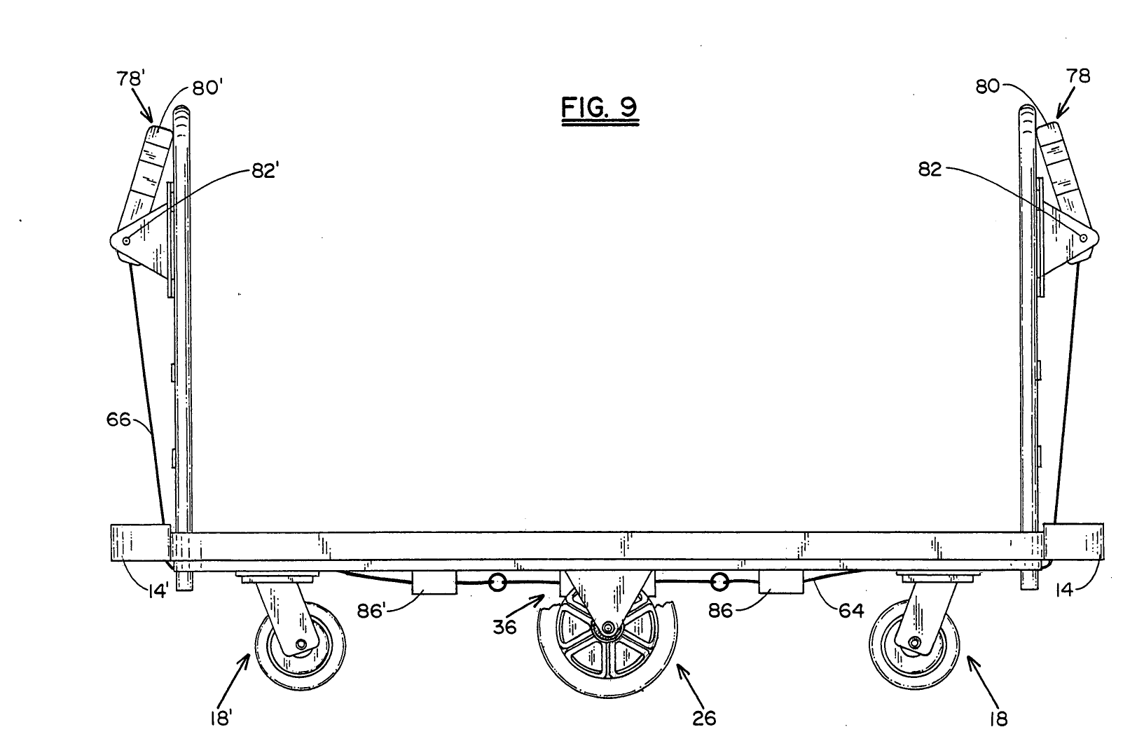

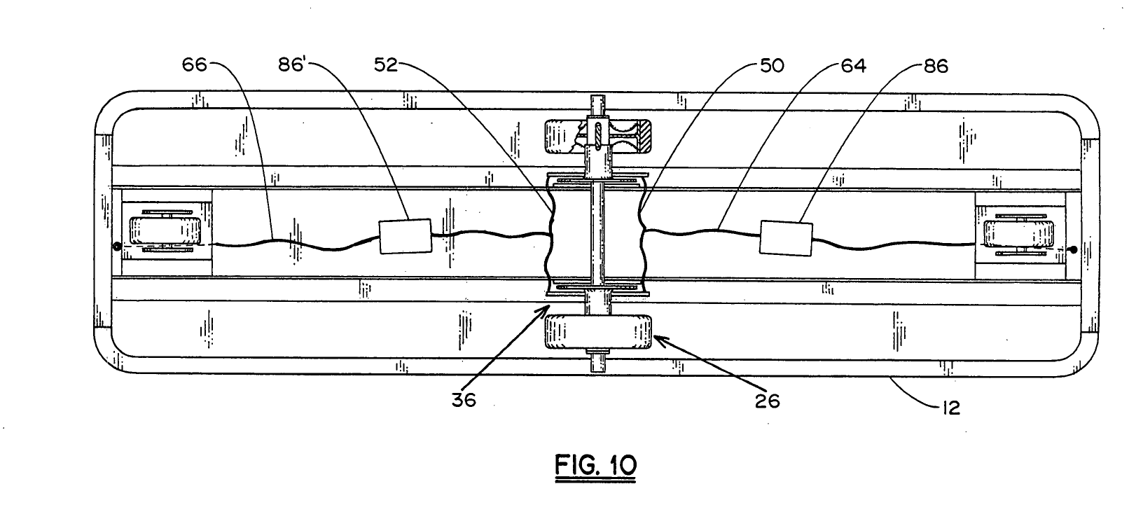

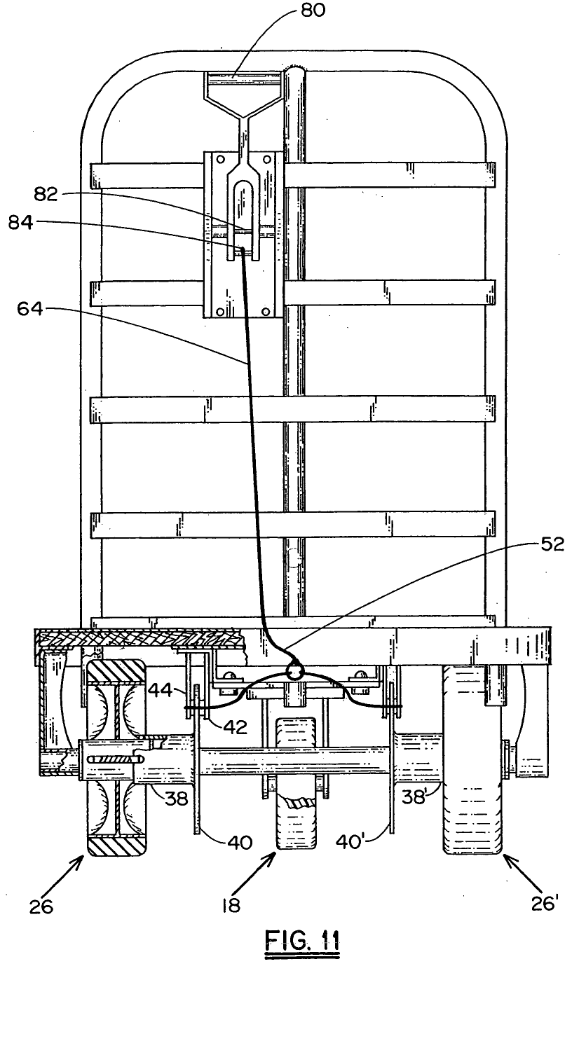

Turning now to FIGS. 7-11, the invention will be described in an embodiment wherein the brakes are normally disengaged, being engaged only upon operator manipulation of a handle assembly. Common reference numerals will be used to denote elements which are the same in both embodiments. All features of cart 10 are the same, as are the two brake assemblies. Again, cables 50 and 52 are affixed at opposite ends to outboard brake plates 44, 44′ and act to apply the brakes in the same manner when the cables are tensioned. In the present embodiment, cable 54 and lever 58 have been eliminated and cables 64 and 66 extend directly from their connections to cables 50 and 52, respectively, for connection at their other ends to handle assemblies 78, 78′ mounted at opposite ends of the cart to structures 34, 34′. Each of assemblies 78, 78′ includes a handle 80, 80′ pivotally mounted upon pin 82, 82′ for movement between lower (FIG. 7) and upper (FIGS. 9 and 11) positions, wherein the brakes are engaged and disengaged, respectively. Cables 64 and 66 are connected to pins 84, 84′ on the opposite side of pivot pins 82, 82′ from the manually engageable portion of handles 80, 80′. Cables 64 and 66 preferably include, at some position below bed 20, spring assemblies 86,86′, a commercially available bundle of coil springs, to compensate for wear in the parts and assists in maintaining tension on the cables when the brakes are engaged.

The second embodiment, wherein the brakes are “normally off,” i.e., are engaged only upon operator manipulation of the handle assembly, is somewhat simpler, and therefore less expensive and easier to install, whereas the first embodiment, wherein the brakes are “normally on,” being released to permit movement of the cart only when a push bar is manually engaged by the operator, provides optimum safety. The braking system is operable from either end of the cart in both embodiments. Although the disclosed embodiments operate in a purely mechanical fashion, it will be understood that hydraulic, electric and other known actuating means may be employed, if desired. Also, while the invention is disclosed, and primary utility is anticipated, in the field of manually powered carts, it is possible that the braking system may be applied to power-driven (electric, gas, diesel, etc.) vehicles, particularly those that are operable from either of two ends.

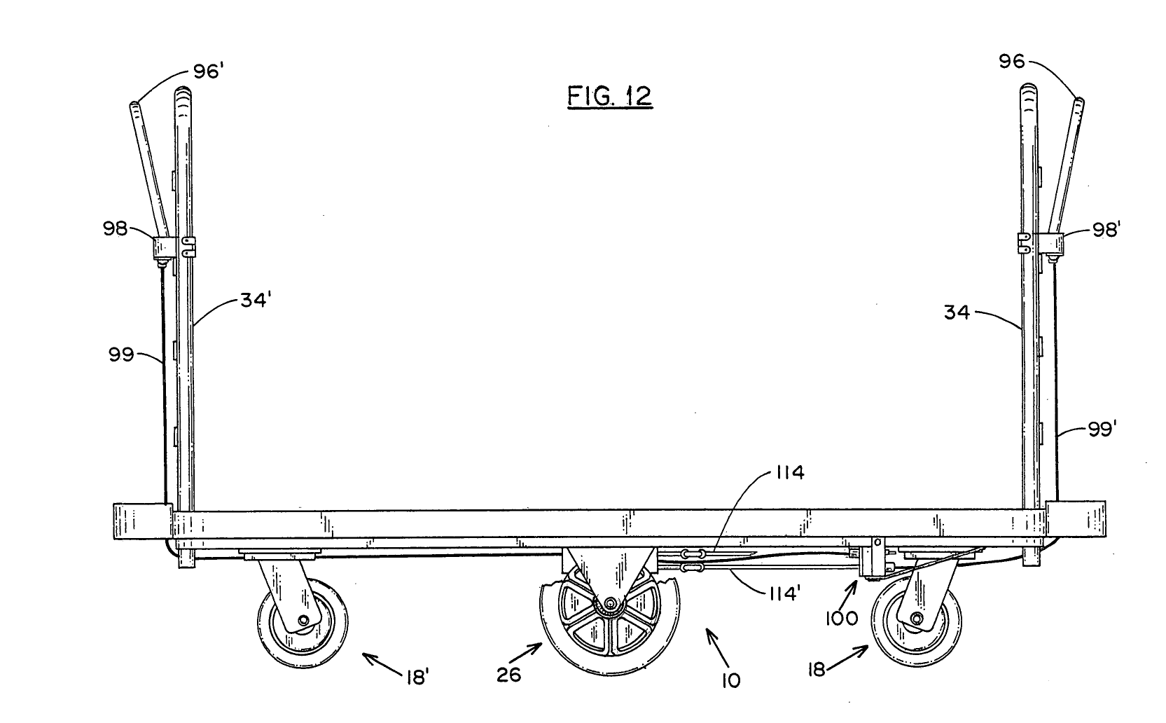

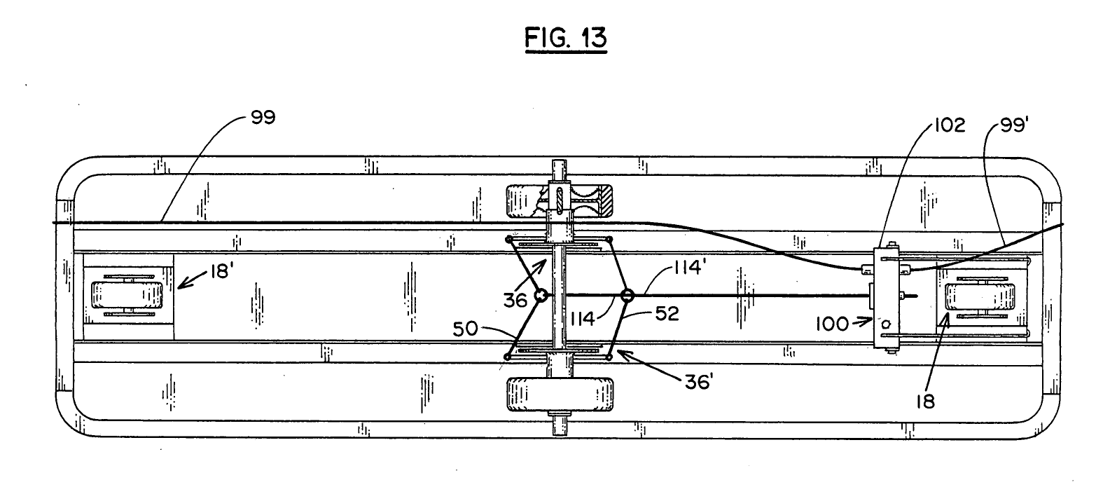

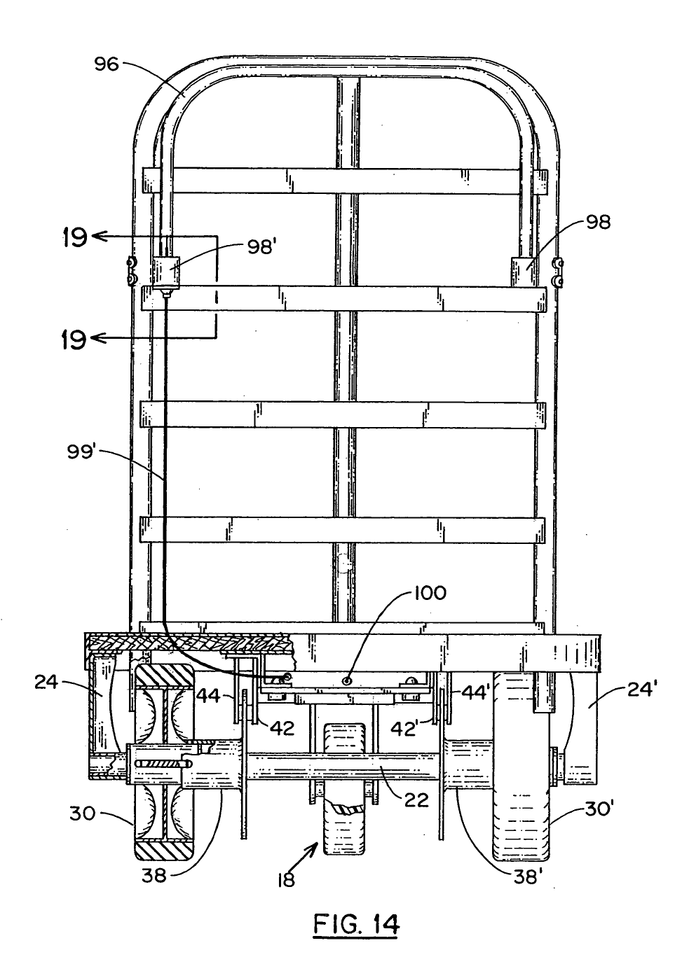

An alternate version of the first embodiment, embodying a preferred construction of the elements which control operation of the braking system, is shown in FIGS. 12 through 20. Common reference numerals are used for elements which are the same as in the first-described version. Cart 10 is the same, conventional, manually propelled cargo truck as before, including frame 12, bumper structures 14, front and rear, pivoting caster assemblies 18, 18′, bed 20, stationary axle 22, wheel supports 24 and wheels 26. In addition, the brake plates, rotor and hub are the same as in the original version with the rotor hub rotationally coupled to the spoked wheels in the same manner, i.e., by the wheel spokes extending into open slots in the hub. The mechanism for controlling operation of the brakes is somewhat different, employing sheathed cables to impart movement to a pivoted lever and to the brake plate cables (or, alternatively, rigid rods) against-the bias of a compressed, coil spring.

FIGS. 12, 13 and 14 show the cart with the preferred version of the brake operating system in side elevation, bottom plan, and end elevation, respectively, which may be compared to FIGS. 1, 2 and 5, the corresponding views of the original version. Rigid rods 51 and 53, which correspond to flexible cables 50 and 52 of the first version, are attached at opposite ends to outer, movable brake plates 44 and 44′, as before. U-shaped push bars 96, 96′ are mounted at opposite ends of the cart 10 upon frame structures 34, 34′ by mounting brackets 98, 98′, as described later in more detail. Sheathed cables 99, 99′ are of a conventional, commercial design, each consisting of a stiff wire contained within and longitudinally movable with respect to a hollow conduit. The wire and conduit of sheathed cable 99 are denoted by reference numerals 99a and 99b, respectively, while sheathed cable 99′ consists of wire 99a′ and conduit 99b′ Sheathed cables 99, 99′ extend between connections to mounting brackets 98, 98′, respectively, at one end to connections with portions of the brake operating system, denoted generally by reference numeral 100, at the other ends.

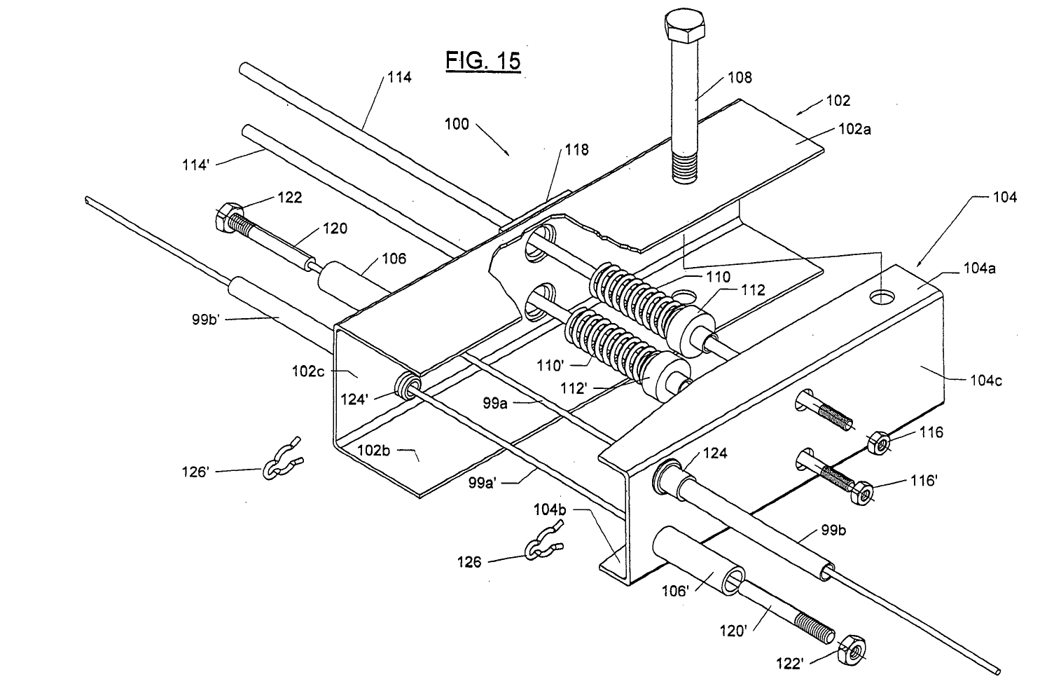

Referring now to FIG. 15, the operable elements of brake operating system 100 are shown in exploded perspective view. Channel member 102 includes upper and lower, parallel plates 102a and 102b, respectively, integrally joined by back plate 102c, forming a U-shaped channel, open on one side. Lever member 104 is likewise in the form of a U-shaped channel, having upper and lower plates 104a and 104b, respectively, integrally joined by back plate 102c. Hollow, tubular member 106 is fixedly connected to channel member back plate 104c in registration with an opening therein, and hollow, tubular member 106′ is fixedly connected to lever member back plate 104c in registration with an opening therein.

When assembled, upper and lower plates 104a and 104b of lever member 104 are received between upper and lower plates 102a and 102b, respectively, of channel member 102. When brake operating system 100 is mounted upon cart 10, channel member 102 is fixedly connected to the frame or other rigid portion of the cart, while lever member 104 is pivotally connected to channel member 102 by bolt 108 which passes through aligned openings in the upper and lower plates of the channel and lever members and is secured by a suitable nut (not shown). A pair of coil springs 110, 110′ are affixed at one end to cylindrical spring retainers 112, 112′, respectively, each of the retainers having relatively larger and smaller diameter portions. Shafts 114, 114′, each threaded at one end and secured by nuts 116, 116′, respectively, extend axially through openings in the respective spring retainers 112, 112′, through the springs and through aligned openings in back plates 102c and 104c. The ends of springs 110, 110′ opposite those attached to retainers 112, 112′ extend through openings in back plate 102c and seat against surface portions of an additional plate 118 which is welded or otherwise fixedly attached to the outer surface of channel back plate 102c. That is, the openings in channel back plate 102c are of slightly larger diameter, and the openings in plate 118 are of slightly smaller diameter than the outside diameter of springs 110, 110′, thus forming retaining seats for the ends of the springs.

The end of wire 99a opposite the end attached to mounting bracket 98 is fixedly attached, e.g., by swaging, to an end of rod 120, and the end of wire 99a′ is swaged to rod 120′, the opposite ends of the rods being threaded and secured by nuts 122, 122′. Rods 120, 120′ extend loosely through tubular members 106, 106′, respectively, with the radial surfaces of nuts 122, 122′ seating against the ends of cylinders 106, 106′, respectively. Collar 124 is fixedly attached to conduit 99b and extends through an opening in lever back plate 104c, being retained by clip 126. Likewise, collar 124′ and conduit 99b′ are mutually attached with collar 124′ extending through an opening in back plate 102c and retained by clip 126′.

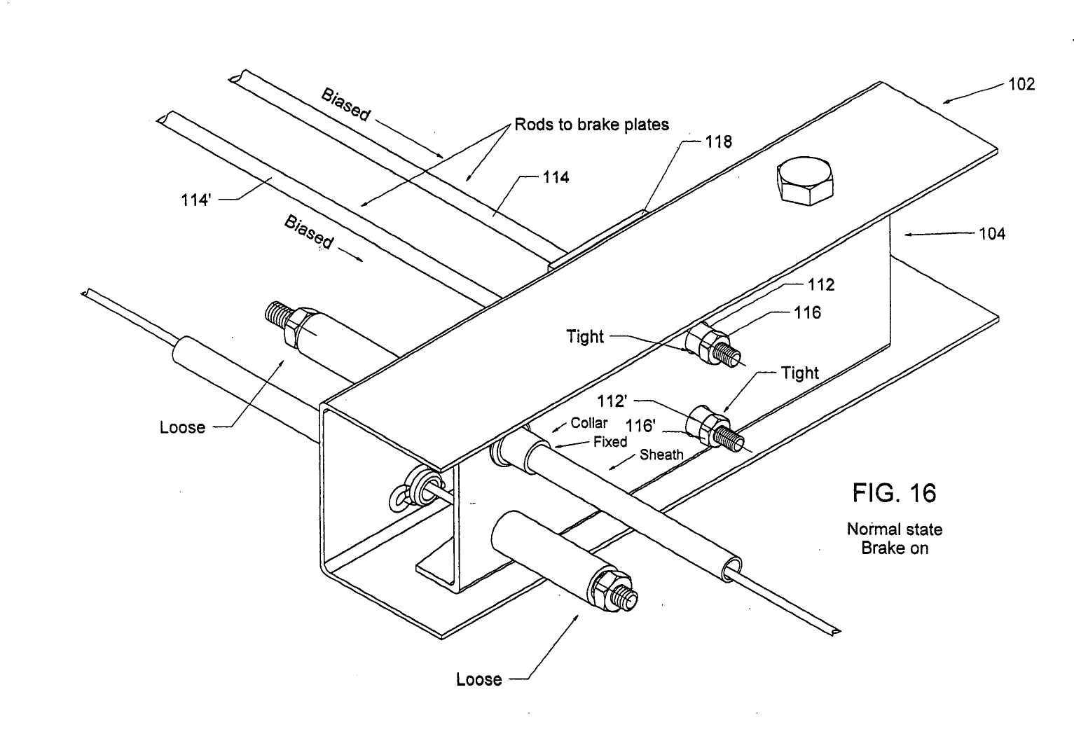

When the elements of braking system 100 are assembled, as in FIG. 16, springs 110 and 110′ are compressed between plate 118 and the larger diameter portions of spring retainers 112, 112′, exerting a biasing force maintaining nuts 116 and 116′ in engagement with the ends of the smaller diameter portions of the spring retainers. Rods 114, 114′ are thus biased toward movement in a direction maintaining tension on rods 51 and 53 and drawing brake plates 44, 44′ into contact with rotors 40, 40′. In this manner, the brakes are effectively applied in the absence of manual actuation (rotation) of either of bars 96, 96′

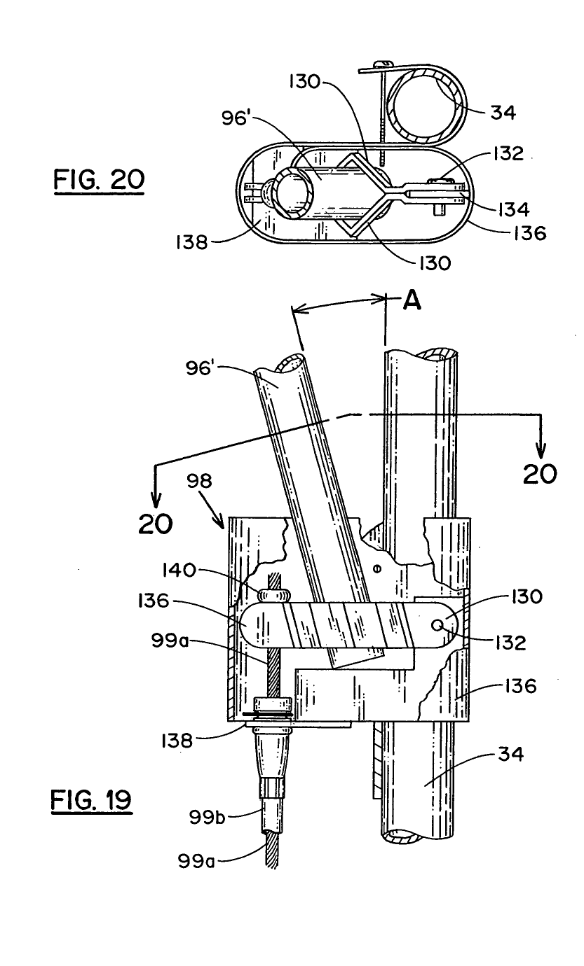

Sheathed cable 99 is connected at one end to portions of brake operating system 100 and at the other end to one of mounting brackets 98 at one end of the cart, and sheathed cable 99′ is connected between the brake operating system and one of mounting brackets 98′ at the other end. More specifically, the sheathed cables are connected to the brake operating system by connecting the ends of wires 99a and 99a′ to the ends of shafts 120 and 120′, respectively, and fixedly attaching terminal ends of conduits 99b and 99b′ to collars 124 and 124′, respectively. The manner of connection of the other ends of the sheathed cables to the mounting brackets is best seen by reference to FIGS. 19 and 20. The lower, free ends of bars 96, 96′ are each captured between opposing sides of a two-piece bracket, the bracket shown in FIGS. 19 and 20 being denoted by reference numeral 130. Bracket 130 is pivotally attached by pin 132 to inwardly extending portion 134 of wall 136 which surrounds the lower end of bar 96 and bracket 130. Conduit 99b is affixed to plate 138 on the lower side of wall 136 and wire 99a is inserted between the two sides of bracket 130 and secured by collar or nut 140.

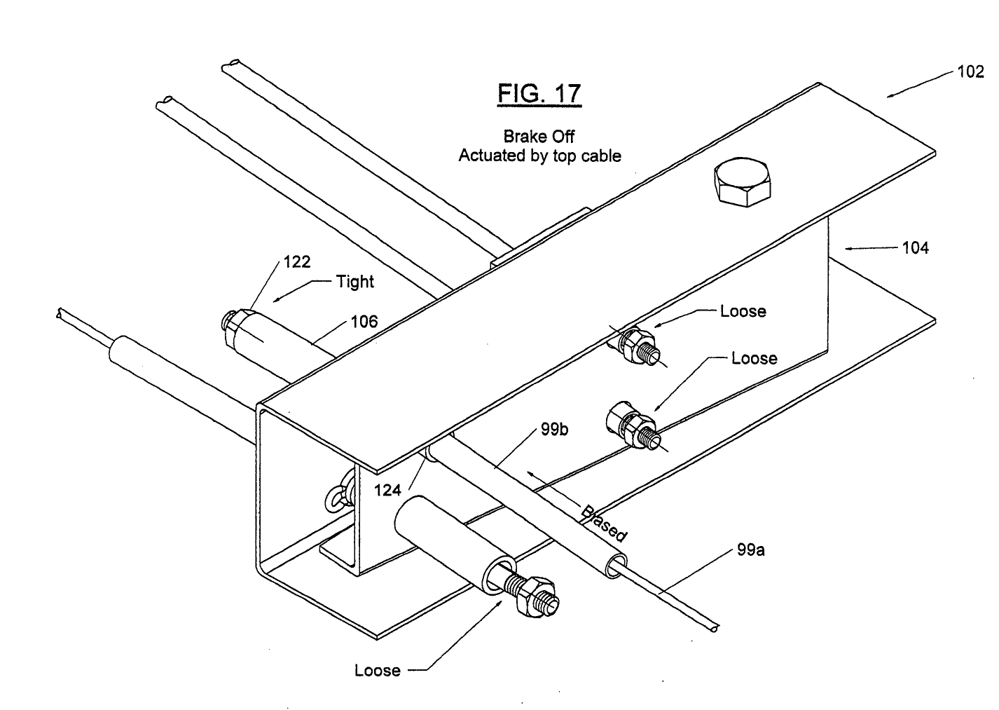

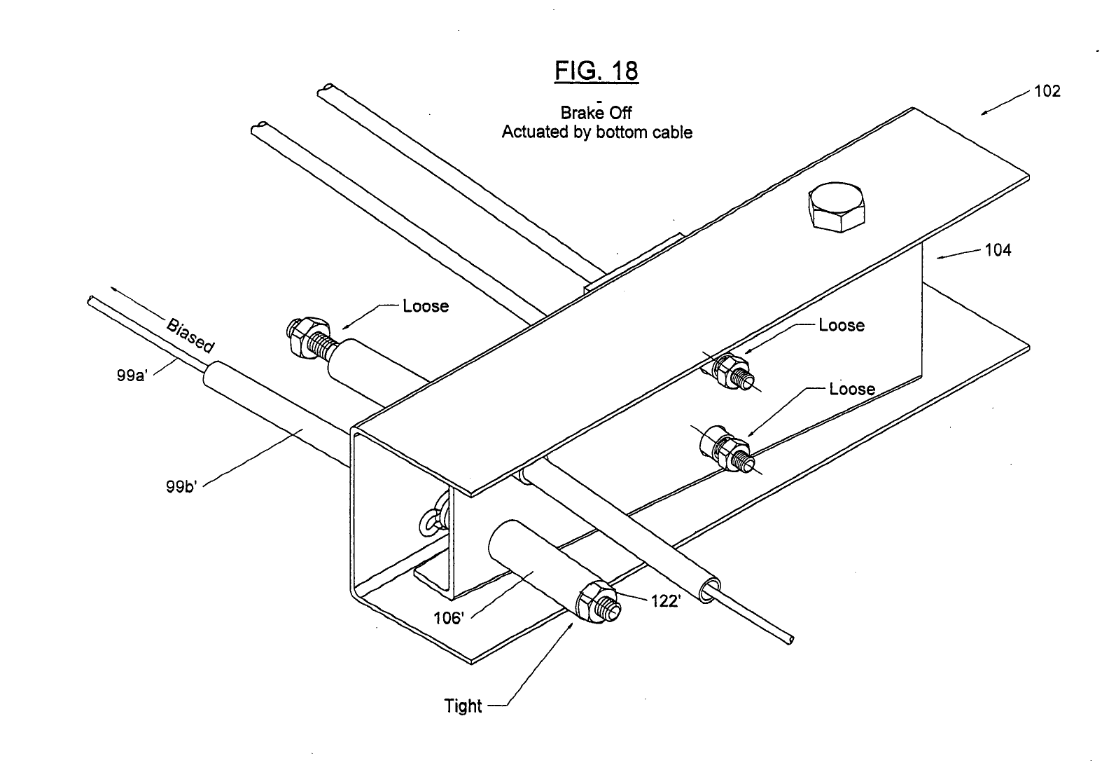

When cart 10 is to be moved, the operator grasps the upper part of one of bars 96 and rotates the bar through angle A (FIG. 19), thereby releasing the brake. Although the mounting brackets and manner of attachment of the sheathed cables are the same at both ends of the cart, the action resulting in brake release is somewhat different. When the brake is released by rotation of the bar to which sheathed cable 99 is attached, wire 99a is pulled toward the right, as seen in FIG. 17. When nut 122 engages the end of cylinder 106, wire 99a cannot be moved axially; however, since the sheathed cable is laterally flexible the force applied to the wire will result in a flexing of the cable which, in effect, shortens the distance between nut 122 and collar 124. This flexing movement has the effect of axially advancing the end of the sheath connected to collar 124, thereby exerting a force on lever 104, rotating the latter against the bias of springs 110, 110′ and releasing the tension on rods 114, 114′. This, in turn, removes the tension on cables 50 and 52, allowing brake plates 44, 44′ to return to their rest positions, out of contact with rotors 40, 40′ When the brake is released by movement of the bar at the other end of the cart, wire 99a′ is pulled toward the left, bringing nut 122′ into engagement with the end of cylinder 106′, with continued axial movement of wire 99a′ rotating lever 104 to the position of FIG. 18, again removing the tension on rods 114, 144′ and cables 50 and 52.

When the bar which has been rotated to release the brake is released, springs 110, 110′ act to rotate lever 104 back to the FIG. 16 position and apply the brake. Thus, regardless of bars 96, 96′ is rotated, lever 104 will be rotated in the same direction, i.e., the direction which releases tension on rods 114, 114′ and cables 50 and 52 to release the brakes.

1. A cargo cart comprising:
a) a rigid frame;
b) a cargo bed having first and second ends and first and second sides mounted to said frame;
c) a pair of wheels of equal diameter mounted to at least one of said frame and bed for rotation about a common axis extending through said sides substantially midway between said ends;
d) first and second swivel casters mounted to at least one of said sides and bed on opposite sides of said common axis for first rotation about respective swivel axes perpendicular to said common axis, and second rotation about respective rotational axes perpendicular to and intersecting said swivel axes;
e) the diameters of said wheels and casters, and the relative positions of said common axis and said rotational axes being such that a flat plane passing through the surfaces of said wheels remote from said bed passes through the surface of not more than one of said casters, whereby said wheels and not more than one of said casters is in contact with a flat support surface at a time; and
f) a braking system selectively operable between a first condition, wherein both of said wheels are free to rotate about said common axis, and a second condition, wherein said braking system inhibits rotation of at least one of said wheels.

2. The cart of claim 1 wherein operation of said braking system inhibits rotation of both of said wheels.

3. The cart of claim 1 wherein said cargo bed is substantially rectangular, said sides being substantially parallel to one another and perpendicular to said ends.

4. The cart of claim 1 and further including means positioned at each of said ends for manual engagement by an operator to move said cart upon said wheels, and wherein said braking system is selectively operable by an operator positioned at either of said ends.

5. The cart of claim 1 and further including at least one member movable between first and second positions to place said braking system in said first and second conditions, respectively.

6. The cart of claim 5 and further including means biasing said member to said second position.

7. The cart of claim 1 wherein said braking system includes a pair of brake assemblies, one mounted inwardly adjacent each of said wheels and jointly operable between said first and second conditions.

8. The cart of claim 7 wherein each of said brake assemblies includes a rotor mounted in rotationally locked relation to a respective one of said wheels, and at least one plate movable out of and into frictional contact with the respective rotor to place said braking system in said first and second conditions, respectively.

9. The cart of claim 8 wherein said rotor of each of said assemblies is mounted for rotation about said common axis.

10. The cart of claim 9 and further including means biasing said plate of each of said brake assemblies into frictional contact with the respective rotor, whereby said braking system is normally in said second condition.

11. The cart of claim 10 wherein said rotor of each of said brake assemblies includes a disc portion and an axially extending hub portion, said hub portion being rotationally locked to said respective one of said wheels.

12. The cart of claim 11 wherein each of said brake assemblies includes one movable plate and one fixed plate, a portion of said rotor of each of said brake assemblies being frictionally engaged between the movable and fixed plate of the respective assembly in said second condition thereof.

13. The cart of claim 12 and further including first and second manually engageable members mounted adjacent said first and second ends, respectively, and connected to said movable caliper of each of said brake assemblies for movement of each of said movable caliper away from engagement with said rotor of the respective assembly.

14. A braking system for a cart having a frame, a load carrying portion mounted to said frame and at least one wheel rotatable about an axis fixed with respect to said frame for support and movement of said load carrying portion over a surface, said wheel including a first hub, a rim, and at least one structural member extending between said first hub and rim, said braking system comprising:
a) at least one rotor having a substantially flat, disc shaped portion with a central axis;
b) a second hub coaxially affixed to said rotor and extending axially therefrom;
c) at least one movable friction plate positioned laterally adjacent a portion of said rotor;
d) locking means for rotationally locking said second hub to said at least one structural member, whereby rotation and inhibiting of rotation are transmitted between said rotor and said wheel; and
e) means for moving said movable friction plate into and out of frictional engagement with said portion of said rotor, thereby inhibiting and allowing, respectively, free rotation of said wheel.

15. The braking system of claim 14 wherein said rotor and said second hub are integrally formed as a single piece.

16. The braking system of claim 14 and further including a stationary friction plate mounted on the opposite side of said portion of said rotor from said movable friction plate, and wherein said rotor is axially movable, whereby movement of said movable friction plate moves said rotor axially to frictionally engage said portion of said rotor between said movable and stationary friction plates.

17. The braking system of claim 14 wherein said cart includes a pair of wheels mounted for rotation about a common axis, each of said wheels including a first hub, a rim and at least one structural member extending between said first hub and rim, and said braking system comprise a pair of brake assemblies mounted adjacent a respective one of said wheels, each of said including a rotor, a second hub, a movable friction plate, locking means for rotationally connecting said second hub of said brake assemblies with said structural member of the adjacent wheel, and means for moving said movable friction plate into and out of frictional engagement with a portion of said rotor, said rotor and second hub of each of said brake assemblies being mounted for rotation about said fixed axis.

18. The braking system of claim 14 wherein said wheel includes a plurality of said structural members and said second hub includes portions mating with each of said structural members to rotationally lock said second hub to said wheel.

19. The braking system of claim 18 wherein said second hub comprises a hollow cylinder having one end fixedly attached to said rotor and the other end in a plane perpendicular to said common axis, and further comprising an axle extending along said common axis upon which said wheel, said second hub and said rotor are rotationally mounted.

20. The braking system of claim 18 wherein said structural members each have a first predetermined width and said second hub portions comprise slots having a second predetermined width, at least as great as said first predetermined width, extending axially into said other end of said cylinder, said wheel and said second hub being mounted upon said axle with said structural members extending into respective ones of said slots to rotationally lock said second hub to said wheel.

21. A braking system for a vehicle having an axle, and a wheel mounted upon said axle, said braking system comprising:
a) a rotor mounted upon said axle;
b) a friction member movable between a first position, wherein said friction member is in physical contact with a portion of said rotor for inhibiting free rotation of said rotor, and a second position, wherein said friction member is spaced from said rotor for permitting free rotation of said rotor;
c) first locking means fixedly attached to said wheel;
d) second locking means fixedly attached to said rotor; and
e) said first and second locking means being so constructed and arranged that relative axial movement of said wheel and rotor from a spaced position to a proximate position places said first and second locking means in relative positions wherein said wheel and rotor are rotationally locked for transmission of rotation from said wheel to said rotor and transmission of said inhibiting of rotation of said rotor to said wheel.

22. The braking system of claim 21 wherein said first locking means comprises at least one structural member extending substantially radially of said wheel.

23. The braking system of claim 22 wherein said at least one structural member comprises a plurality of spokes of said wheel.

24. The braking system of claim 21 wherein said axle has opposite ends and said vehicle includes a pair of wheel, one mounted adjacent each of said ends, said braking system further including a pair of rotors, one mounted inwardly adjacent each of said wheels, a pair of friction members selectively movable into and out of frictional engagement with a respective one of said rotors, first locking means affixed to each of said wheels and second locking means affixed to each of said rotors.

25. The braking system of claim 21 wherein said vehicle includes first and second ends and further including first and second actuating members adjacent said first and second ends, respectively, for selective movement by an operator adjacent one of said ends to move said friction member from one to the other of said first and second positions.

26. The braking system of claim 25 wherein said first and second actuating members are movable by an operator to move said friction member from said first position to said second position, and further including means biasing said friction member toward movement to said first position.

27. The braking system of claim 26 wherein said biasing means comprises at least one spring.

28. The braking system of claim 25 wherein said first and second actuating members include first and second sheathed cables, respectively, each including a rigid wire at least partially enclosed by, and axially movable with respect to, a hollow conduit.

29. The braking system of claim 28 wherein movement of said friction member from said first to said second position is effected by an operator at said first end by axial movement of said wire of said first sheathed cable, with said conduit of said first sheathed cable remaining stationary, and by an operator at said second end by axial movement of said conduit of said second sheathed cable, with said wire of said second sheathed cable remaining stationary.

30. A braking system for a vehicle having a rigid frame, a cargo carrying bed having upper and lower surfaces and at least one wheel having a plurality of spokes rotatable about a central axis, said braking system comprising:
a) a disc-like rotor;
b) a cylindrical hub affixed to and having one end extending axially from said rotor;
c) a plurality of slots extending into said one end of said hubs;
d) means supporting said hub adjacent said wheel with at least some of said spokes extending into at least some of said slots to rotationally lock said hub and rotor to said wheel; and
e) a friction member movable between a first position, in physical contact with a portion of said rotor to inhibit rotation of said rotor and wheel, and a second position, spaced from said rotor to permit free rotation of said rotor and said wheel.

31. The braking system of claim 30 and further including spring means biasing said friction member toward said first position thereof.

32. The braking system of claim 31 and further including means for manually moving said friction member to said second position, against the bias of said spring means.

33. The braking system of claim 32 wherein the number of said spokes and said slots are equal.

34. The braking system of claim 33 wherein said means for manually moving includes a lever mounted for pivotal movement with respect to said bed, and means connecting said lever to said friction member.

35. The braking system of claim 34 wherein said means for manually moving include an actuating member manually engageable by an operator adjacent said vehicle, and at least one sheathed cable comprising a first, rigid wire at least partially enclosed by a first, hollow conduit, said sheathed cable extending between said actuating member and said lever.

36. The braking system of claim 32 wherein said cart has first and second, opposite ends, and wherein said means for manually moving comprise first and second actuating members mounted at said first and second ends, respectively, for selective movement of either of said actuating members to move said friction member to said second position thereof.

37. The braking system of claim 36 wherein said means for manually moving further includes first and second, elongated connecting members fixedly attached to, and movable in response to movement of, said first and second actuating members, respectively.

38. The braking system of claim 37 wherein said first and second connecting members comprise first the second sheathed cables, respectively.

39. A braking system for a cargo cart having a frame with first and second ends, a load carrying bed having upper and lower surfaces mounted to said frame, and at least one pair of wheels rotatable about a common axis for movement of said cart over a surface, each of said wheels having a plurality of spokes, said braking system comprising:
a) at least one braking member movable between a first position, wherein said braking member inhibits rotation of at least one of said wheels, and a second position, wherein said wheels are freely rotatable;
b) a first operating member mounted at said first end of said cart for manual engagement by an operator adjacent said first end to move said braking member from one to the other of said first and second positions;
c) a second operating member mounted at said second end of said cart for manual engagement by an operator adjacent said second end to move said braking member from said one to said other of said first and second positions; and
d) coupling means connecting said first and second operating members to said braking member for movement of the latter in response to independent movement of either of said operating members, at least a portion of said coupling means being mounted beneath said lower surface of said bed.

40. The braking system of claim 39 and further including spring means biasing said braking member toward said one position thereof.

41. The braking system of claim 40 and further including a disc-like rotor rotationally coupled to at least one of said wheels, and wherein said braking member comprises a brake plate positioned in and out of frictional contact with said rotor when in said first and second positions, respectively.

42. The braking system of claim 41 wherein said coupling means include a rotatable lever.

43. The braking system of claim 42 wherein said coupling means further include a first sheathed cable extending between said first operating member and said lever, and a second sheathed cable extending between said second operating member and said lever.

44. The braking system of claim 41 and further including a hub member fixedly attached to said rotor and slidingly engaged with at least one of said spokes to rotationally couple said rotor to said at least one wheel.

45. The braking system of claim 44 wherein said hub member comprises a cylinder mounted coaxially with said common axis and having at least one slot extending into one end with one of said spokes positioned between opposing edges of said slot.

46. The braking system of claim 45 wherein said at least one wheel includes a plurality of spokes and said hub member includes a plurality of slots, each of said spokes positioned between opposing edges of a corresponding one of said slots.
